(19) United States
(12) Patent Application Publication
(10) Pub. No.: US 2010/0146256 A1
(43) Pub. Date: Jun. 10, 2010

(54) Mixed-Mode ROM/RAM Booting Using an Integrated Flash Controller with NAND-Flash, RAM, and SD Interfaces

(75) Inventors: Jianjun Luo, Sunnyvale, CA (US); Chris Tsu, Saratoga, CA (US); Charles C. Lee, Cupertino, CA (US); Ming-Shiang Shen, Taipei Hsien (TW)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 12/651,321

(22) Filed: Dec. 31, 2009

Related U.S. Application Data
(63) Continuation-in-part of application No. 09/478,720, filed on Jan. 6, 2000, now Pat. No. 7,257,714.
Application No. 09/478,720 is a continuation-in-part of application No. 11/466,759, filed on Aug. 23, 2006, now Pat. No. 7,702,831.
Application No. 11/466,759 is a continuation-in-part of application No. 10/789,333, filed on Feb. 26, 2004, now Pat. No. 7,318,117.
Application No. 10/789,333 is a continuation of application No. 11/679,716, filed on Feb. 27, 2007.

(51) Int. Cl. G06F 15/177; G06F 12/00; G06F 12/02

(52) U.S. Cl. 713/2; 711/103; 711/E12.001; 711/E12.008; 711/104

(57) ABSTRACT

A Secure Digital (SD) flash microcontroller includes a memory interface to SRAM or DRAM, a flash-memory interface, and a SD interface to an SD bus. The flash memory can be on a flash bus or on the SD bus. The microcontroller is booted from boot code stored in the flash memory. An initial boot loader is read from the first page of flash by a state machine and written to a small RAM. A central processing unit (CPU) in the microcontroller reads instructions from the small RAM, executing the initial boot loader, which reads more pages from flash. These pages are buffered by the small RAM and written to a larger DRAM. Once an extended boot sequence is written to DRAM, the CPU toggles a RAM_BASE bit to cause instruction fetching from DRAM. Then the extended boot sequence is executed from DRAM, copying an OS image from flash to DRAM.

### RELATED APPLICATION

This application is a continuation of “Mixed-Mode ROM/RAM Booting Using an Integrated Flash Controller with NAND-Flash, RAM, and SD Interfaces”, U.S. Ser. No. 11/679,716, filed Feb. 27, 2007.

This application is a continuation-in-part of the co-pending application for “Electronic Data Storage Medium with Fingerprint Verification Capability”, U.S. Ser. No. 09/478,720, filed Jan. 6, 2000. This application is also a CIP of “Flash Memory Controller for Electronic Data Flash Card”, U.S. Ser. No. 11/466,759, filed Aug. 23, 2006, which is a CIP of “System and Method for Controlling Flash Memory”, U.S. Ser. No. 10/789,333, filed Feb. 26, 2004, now abandoned.

This application is related to “Flash drive/reader with serial-port controller and flash-memory controller mastering a second RAM-buffer bus parallel to a CPU bus”, U.S. Ser. No. 10/605,140, filed Sep. 10, 2003, now U.S. Pat. No. 6,874,044.

### FIELD OF THE INVENTION

This invention relates to bootable computer systems, and more particularly to booting from multiple types of memories.

### BACKGROUND OF THE INVENTION

Computers once required a complex series of steps to initialize and make them ready to run programs. Instructions for bootstrapping the computer were loaded into the computer after power-on, such as by manually toggling switches representing the 1's and 0's of bootstrap instructions on the front panel. The computer was brought from a dead state into a useful state, like lifting the computer up by its own bootstraps.

More recently, computers still execute a complex sequence of instructions after power-on to boot the computer and load its operating system (OS). The initial instructions may reside in a read-only memory (ROM), along with a personal computer's Basic Input-Output System (BIOS). The operating system such as Windows may be loaded from the hard disk, and when booting is complete the OS can execute user programs. Various system checks such as peripheral device and memory detection and sizing can be performed during booting.

Mass storage devices such as hard disks are being replaced or supplemented with solid-state mass storage such as flash memories. Flash memories use non-volatile memory cells such as electrically-erasable programmable read-only memory, (EEPROM), but are not randomly accessible at the byte level. Instead, whole pages or sectors of 512 bytes or more are read or written together as a single page. NAND flash memory is commonly used for data storage of blocks. Pages in the same block may have to be erased together, and limitations on writing may exist, such as only being allowed to write each page once between erases.

Program code is often stored in randomly-accessible memory such as a ROM or NOR flash memory. Since NOR flash memory is byte-addressable, NOR flash can store code that can be executed. Byte-addressing is needed to execute code, since branch and jump instructions may have a target that is at a random location that must be fetched next. The target may be byte-addressable. Since boot routines execute instructions one at a time, rather than a whole page at a time, randomly-accessible memory is needed for boot-code execution.

Small portable devices such as personal digital assistants (PDA), multi-function cell phones, digital cameras, music players, etc. have a central processing unit (CPU) or microcontroller that must be booted just as a PC or host CPU must be booted. These small devices are often quite cost and size sensitive. Having a NOR flash or ROM may increase the size and cost of these portable devices.

NAND flash memory is less expensive than NOR flash memory, and thus preferable from a cost standpoint. NAND flash memory may already be present on some devices such as cell phones or music players as the primary mass storage memory. It is thus desirable to use NAND flash memory to store boot code.

What is desired is a multi-bus-interface device that can access several different types of memory. It is desired to boot a processor inside the device using boot code that is stored in several of these different types of memory.

### BRIEF DESCRIPTION OF THE DRAWINGS

FIG. 1 shows a microcontroller with multiple memory interfaces.

FIG. 2 shows a microcontroller with a shared flash/SD interface.

FIG. 3 shows a SD flash microcontroller without a separate NOR flash memory.

FIG. 4 shows a SD flash microcontroller with a DRAM-SRAM interface.

FIG. 5 is a block diagram of a SD flash microcontroller with multiple bus interfaces.

FIG. 6 highlights dual-memory booting from both a RAM and a ROM.

FIG. 7 shows that instructions are read over path D from ROM 44 when RAM_BASE is 0, and over path E from RAM 34 when RAM_BASE is set to 1.

FIG. 8 is a flowchart of booting from ROM and RAM by toggling a RAM_BASE bit and resetting.

FIG. 9 shows boot code stored in a NAND flash memory.

FIG. 10 highlights booting the SD flash microcontroller from multiple memories.

FIGS. 11A-B is a flowchart of booting a SD flash microcontroller from flash, SRAM, and DRAM.

### DETAILED DESCRIPTION

The present invention relates to an improvement in multi-memory booting. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

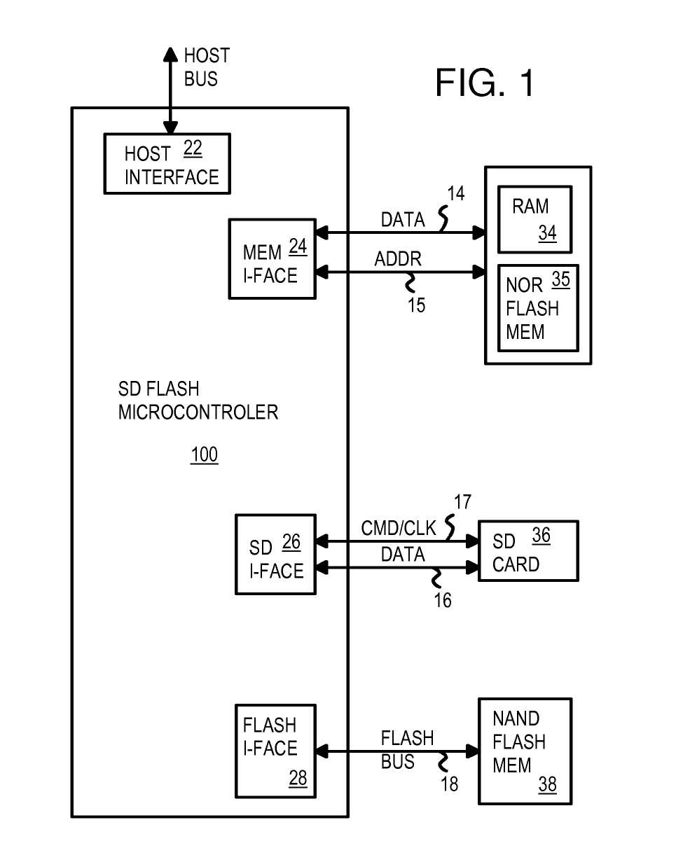

FIG. 1 shows a microcontroller with multiple memory interfaces. SD flash microcontroller 100 has a local processor that is booted from attached memory. SD flash microcontroller 100 can be a controller for a portable device such as a phone, camera, PDA, media player, etc. SD flash microcontroller 100 can read and write data from RAM 34 using memory interface 24, which drives addresses onto address bus 15 and transfers data over memory data bus 14. NOR flash memory 35 is also connected to buses 14, 15 and can be read by memory interface 24, since NOR flash memory 35 is byte or word addressable as is RAM 34.

Boot code can reside in NOR flash memory 35 since memory interface 24 can read individual bytes or words from NOR flash memory 35. Words can be a few bytes, such as 4 bytes, 8 bytes, or 16 bytes. Words are much smaller than the 512-byte sectors or pages that are accessed by a mass-storage device.

SD flash microcontroller 100 can also read pages of data from flash memory 38. Flash interface 28 generates commands and transfers 512-byte blocks of data over flash bus 18 to flash memory 38.

SD flash microcontroller 100 may also connect to one or more removable Secure Digital (SD) cards or to a SD host on a SD bus. SD interface 26 generates and receives commands or clock signals on SD command bus 17, and transfers data packets over SD bus 16 to SD card 36.

A host such as a PC may connect to SD flash microcontroller 100 over SD bus 16, or over a separate host bus. Host interface 22 can connect directly to a host over a host bus. Host interface 22 is optional and not needed when the host connects over SD bus 16.

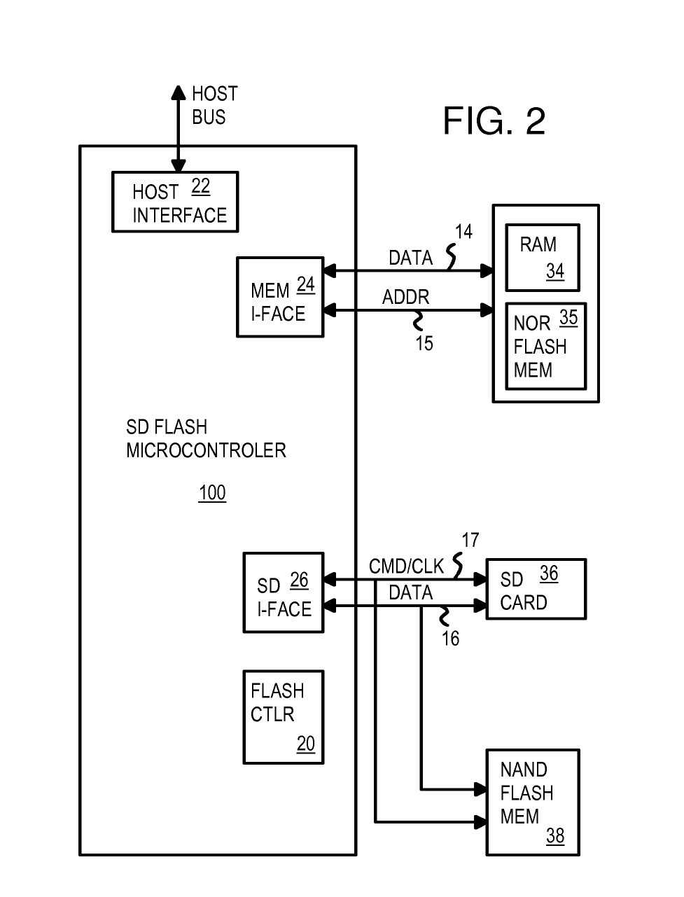

FIG. 2 shows a microcontroller with a shared flash/SD interface. SD card 36 and flash memory 38 both are able to transfer data on SD bus 16. When flash memory 38 is accessed, flash controller 20 generates packets containing flash commands that are sent over SD bus 16 by SD interface 26. Flash memory 38 reads these packets to extract the flash commands, and responds with flash data that is encapsulated in packets that are sent over SD bus 16. The flash interface is similar enough to the SD interface that some kinds of flash memory 38 may be installed directly on SD bus 16. This bus sharing reduces the pincount of SD flash microcontroller 100, reducing cost.

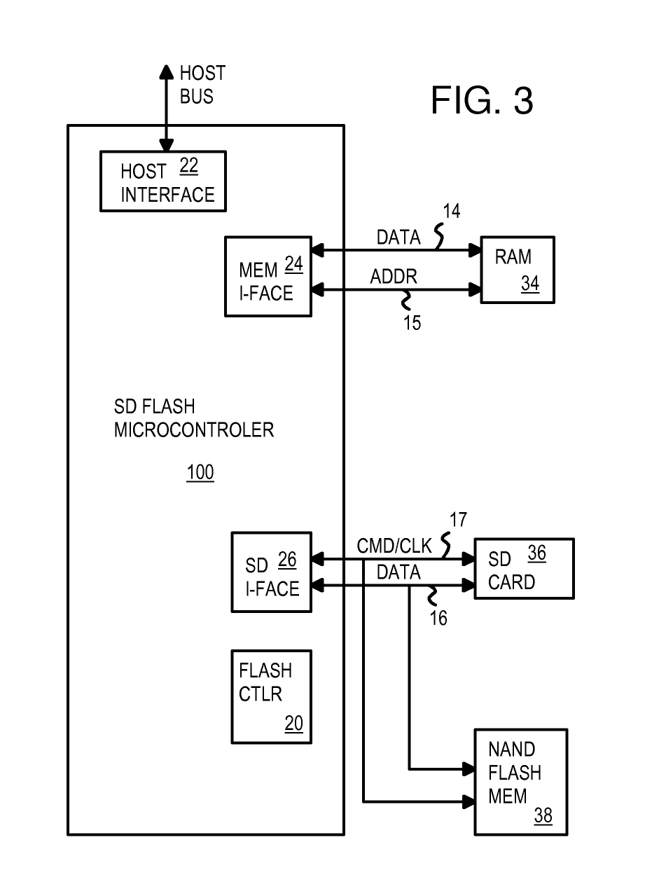

FIG. 3 shows a SD flash microcontroller without a separate NOR flash memory. NOR flash memory 35 of FIGS. 1-2 is removed. Instead, a state machine or other hardwired logic inside SD flash microcontroller 100 acts as an initial boot loader, reading boot code from a first block and first page of flash memory 38. SD interface 26 is activated to read the initial boot loader code from flash memory 38 during initialization.

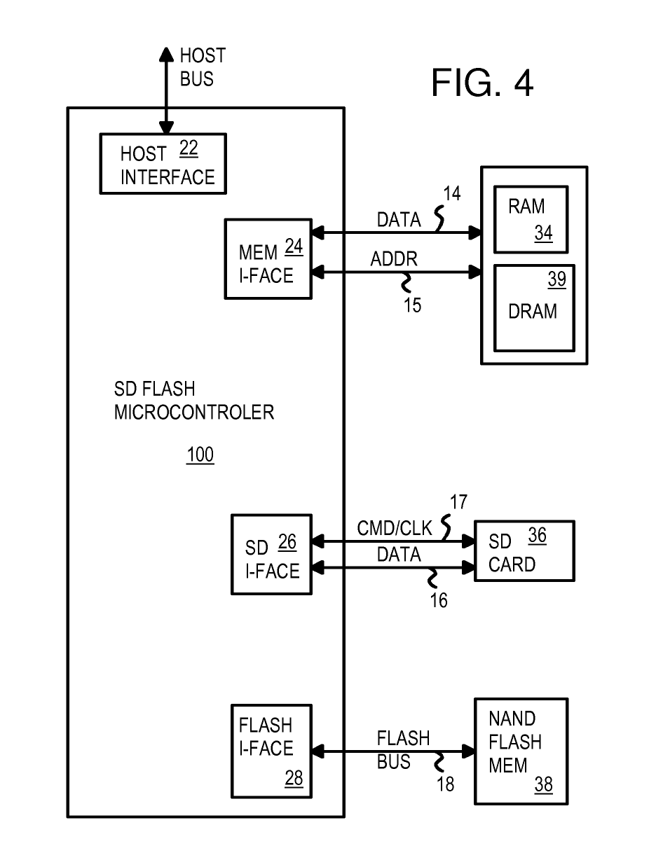

FIG. 4 shows a SD flash microcontroller with a DRAM-SRAM interface. RAM 34 can be a static RAM, while DRAM 39 is a dynamic-random-access memory (DRAM). Memory interface 24 is able to generate DRAM control signals and SRAM control signals, using memory data bus 14 to access both RAM 34 and DRAM 39.

Memory interface 24 may have both a SRAM and a DRAM interface. Additional pulsed control signals such as RAS, CAS (not shown) may be used by memory interface 24 for accessing DRAM 39, and addresses may be multiplexed for row and column addresses. DRAM 39 allows for a much larger memory size at a lower cost than RAM 34. However, memory interface 24 must generate the additional DRAM control signals and ensure that DRAM 39 is refreshed, either using external refresh, or an internal refresh controller within DRAM 39.

Flash memory 38 can reside on flash bus 18 and connect directly to flash interface 28, or may reside on SD bus 16 as shown in FIGS. 2-3. Host interface 22 may not be present on some embodiments.

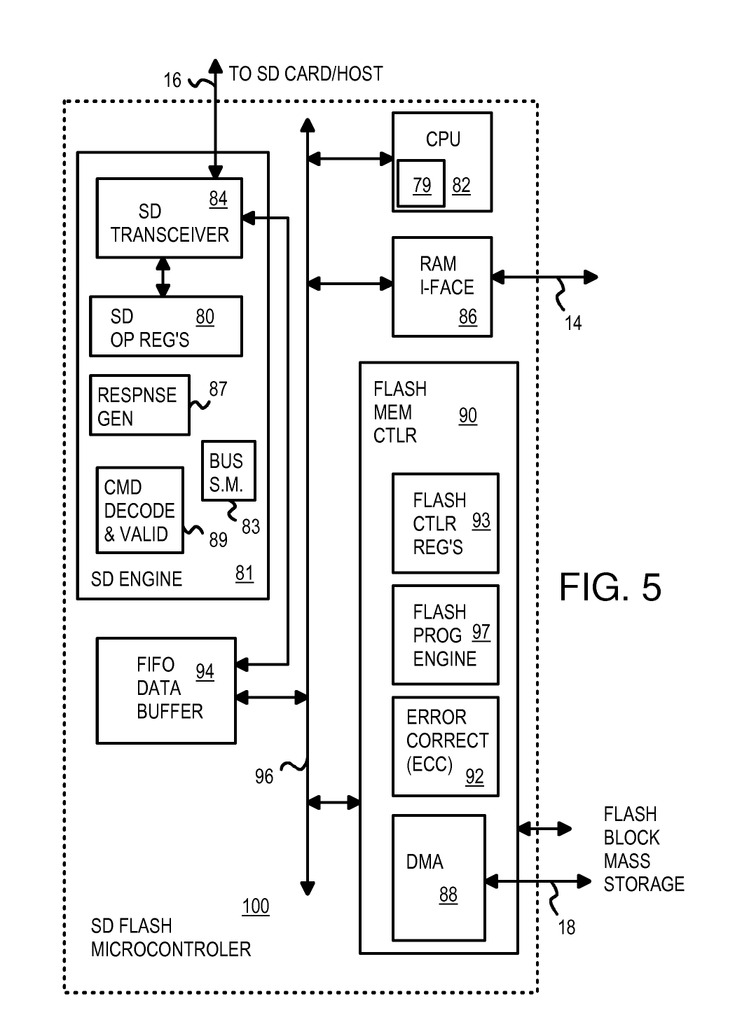

FIG. 5 is a block diagram of a SD flash microcontroller with multiple bus interfaces. SD flash microcontroller 100 can be booted from external flash memory.

Internal bus 96 connects CPU 82 with RAM 86, FIFO data buffer 94, direct-memory access (DMA) engine 88, and flash-memory controller 90. CPU 82 executes instructions read from external RAM over memory data bus 14 through RAM interface 86, using cache 79 to cache instructions and/or data.

DMA engine 88 can be programmed to transfer data between FIFO data buffer 94 and flash-memory controller 90. CPU 82 can operate on or modify the data by reading the data over bus 96. Cache 79 and external RAM can store instructions for execution by the CPU and data operated on by the CPU.

SD transceiver 84 connects to the clock CLK and parallel data lines D0:3 of SD bus 16 and contains both a clocked receiver and a transmitter. An interrupt to CPU 82 can be generated when a new command is detected on SD bus 16. CPU 82 can then execute a routine to handle the interrupt and process the new command.

SD operating registers 80 include the protocol registers required by the SD specification. Registers may include a data-port, write-protect, flash select, flash status, interrupt, and identifier registers. Other extension registers may also be present.

Command decode and validator 89 detects, decodes, and validates commands received over SD bus 16. Valid commands may alter bus-cycle sequencing by bus state machine 83, and may cause response generator 87 to generate a response, such as an acknowledgement or other reply. Different routines can be executed by CPU 82 or different transfer lengths can be performed by DMA engine 88 in response to the byte or sector capacity detected by command decode and validator 89.

The transmit and receive data from SD engine 81 is stored in FIFO data buffer 94, perhaps before or after passing through a data-port register in SD operating registers 80. Commands and addresses from the SD transactions can also be stored in FIFO data buffer 94, to be read by CPU 82 to determine what operation to perform.

Flash-memory controller 90 includes flash data buffer 98, which may contain the commands, addresses, and data sent over internal flash bus 18 to one or more flash mass-storage chips. Data can be arranged in flash data buffer 98 to match the bus width of internal flash bus 18, such as in 32 or 94-bit words. DMA engine 88 can be programmed by CPU 82 to transfer a block of data between flash data buffer 98 and FIFO data buffer 94.

Flash control registers 93 may be used in conjunction with flash data buffer 98, or may be a part of flash memory buffer 98. Flash-specific registers in flash control registers 93 may include a data port register, interrupt, flash command and selection registers, flash-address and block-length registers, and cycle registers.

Error-corrector 92 can read parity or error-correction code (ECC) from flash mass storage chips and perform data corrections. The parity or ECC bits for data in flash data buffer 98 that is being written to flash mass storage chips can be generated by error-corrector 92.

Flash programming engine 97 can be a state machine that is activated on power-up reset. Flash programming engine 97 programs DMA engine 88 with the address of the boot loader code in the first page of the external flash mass-storage chip, and the first address in cache 79 or in another local RAM, or in external RAM through RAM interface 86. Then flash programming engine 97 commands DMA engine 88 to transfer the boot loader from the flash mass storage chip to cache 79 or the other small RAM, or to the external RAM. CPU 82 is then brought out of reset, executing the boot loader program starting from the first address in cache 79 or the small RAM. The boot loader program can contain instructions to move a larger control program from the flash mass storage chip to external RAM through RAM interface 86. Thus SD flash microcontroller 100 is booted without an internal ROM on internal bus 96.

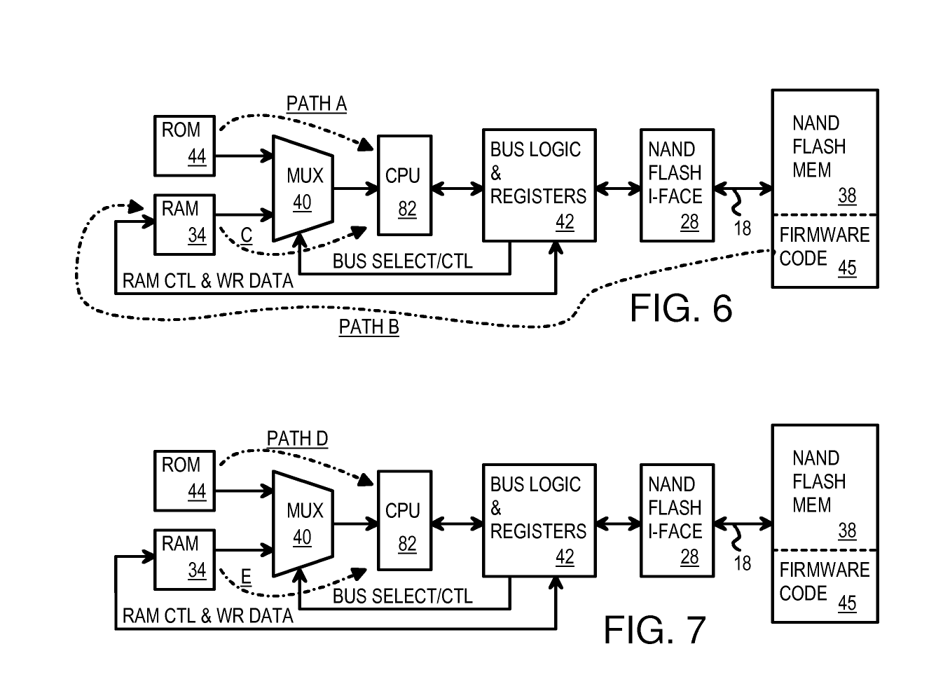

FIG. 6 highlights dual-memory booting from both a RAM and a ROM. Blocks are shown in a flow-path diagram to highlight data flows during booting. After power is first applied and CPU 82 leaves reset, instructions are fetched from ROM 44, which could be a small ROM or hardwired logic in SD flash microcontroller 100. Mux 40 connects ROM 44 to CPU 82. Bus logic and registers 42 include control registers and logic that control mux 40, allowing initial boot instructions to flow over path A from ROM 44 to CPU 82.

The initial instructions from ROM 44 include a boot loader program that reads pages of data from flash memory 38. Firmware code 45 is read from flash memory 38 by flash interface 28 and sent over path B to be written into RAM 34, which can be the external RAM accessed through RAM interface 86 (FIG. 5).

Once firmware code 45 is copied to RAM 34, the initial boot loader program executing on CPU 82 writes a control register in bus logic and registers 42 that toggles to a RAM_BASE mode. In the RAM_BASE mode, bus logic and registers 42 controls mux 40 to connect RAM 34 to CPU 82, rather than ROM 44. Instructions from the copy of firmware code 45 that was written to RAM 34 are now read directly by CPU 82 over path C. Further data can be read from flash memory 38 by CPU 82 until the OS is installed and can execute user programs.

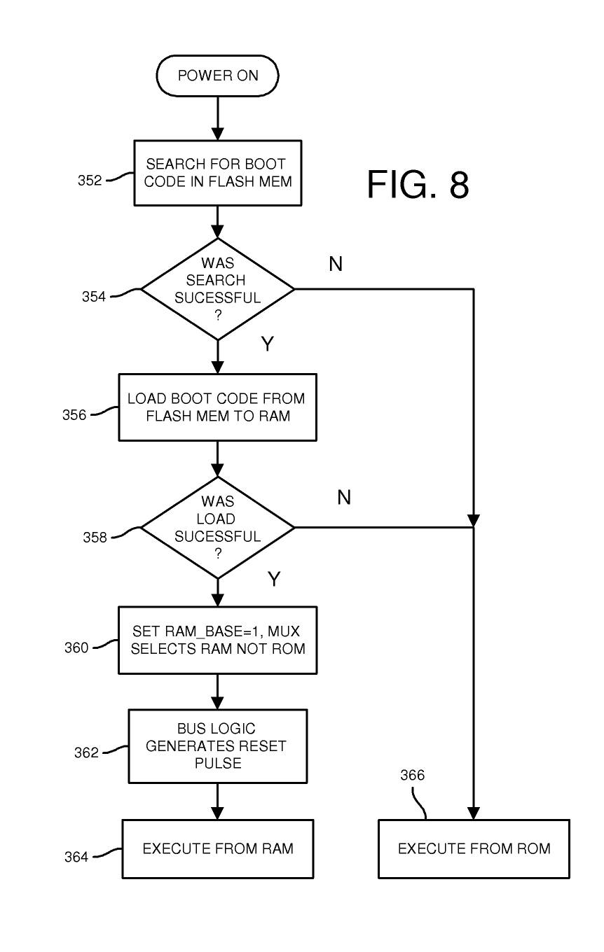

In some embodiments, CPU 82 can read directly from either ROM 44 or from RAM 34 by changing the controls to mux 40. For example, a control register in bus logic and registers 42 can be written by CPU 82 to toggle between reading ROM 44 and RAM 34. FIG. 7 shows that instructions are read over path D from ROM 44 when RAM_BASE is 0, and over path E from RAM 34 when RAM_BASE is set to 1. A reset may be required in some embodiments when RAM_BASE is changed.

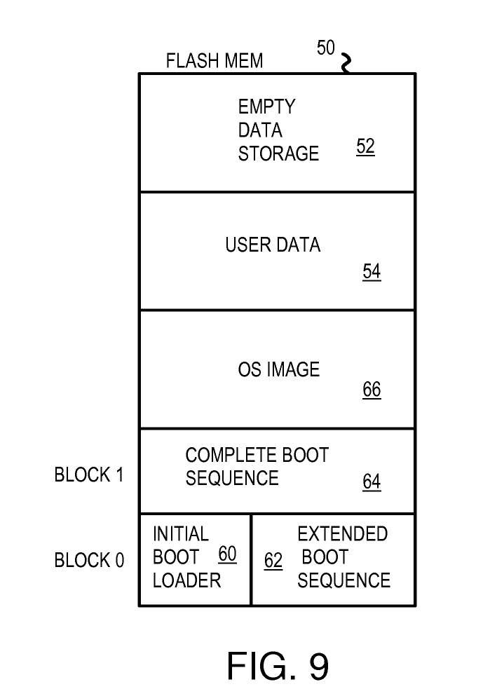

FIG. 8 is a flowchart of booting from ROM and RAM by toggling a RAM_BASE bit and resetting. When power is applied and the CPU comes out of reset, a search is made in the flash memory for the initial boot code, step 352. The boot code may be located at the first page of the first block of flash, and some flash memory chip may automatically transfer this data after a reset or power-on. Otherwise, the CPU or other logic searches for the boot code by reading the first page of flash. The existence of boot code can be determined by matching a signature or other data in the first few bytes of the first page. For example, a special flag such as AA55 may be placed at the beginning of the boot code, and the logic can check for this value to determine if the search was successful. If there is no boot code present, then a default value such as FFFF is read from the flash memory.

When the search of the flash was not successful and boot code was not found in flash, step 354, then the RAM_BASE bit is cleared. Mux 40 or other bus logic connects ROM 44 to CPU 82, and boot code is read from ROM 44 and executed, step 366.

When the search of the flash was successful and found boot code, step 354, then boot code is read from flash memory, step 356. This boot code is written to external RAM 34 through external RAM interface 86, or to a small boot RAM inside SD flash microcontroller 100. When this load from flash memory is not successful, step 358, then the RAM_BASE bit is cleared. Mux 40 or other bus logic connects ROM 44 to CPU 82, and boot code is read from ROM 44 and executed, step 366.

When this load from flash memory is successful, step 358, then the RAM_BASE bit is set to 1, step 360. This causes bus logic and registers 42 to control mux 40 to connect RAM 34 to CPU 82, rather than ROM 44. Bus logic and registers 42 generates a reset pulse, step 362, and after reset CPU 82 reads instructions from the first address in RAM 34, which is the boot loader code earlier read from flash memory in step 356. Boot code is read from RAM and executed, step 364. Once the OS is loaded, user programs or other applications can be executed.

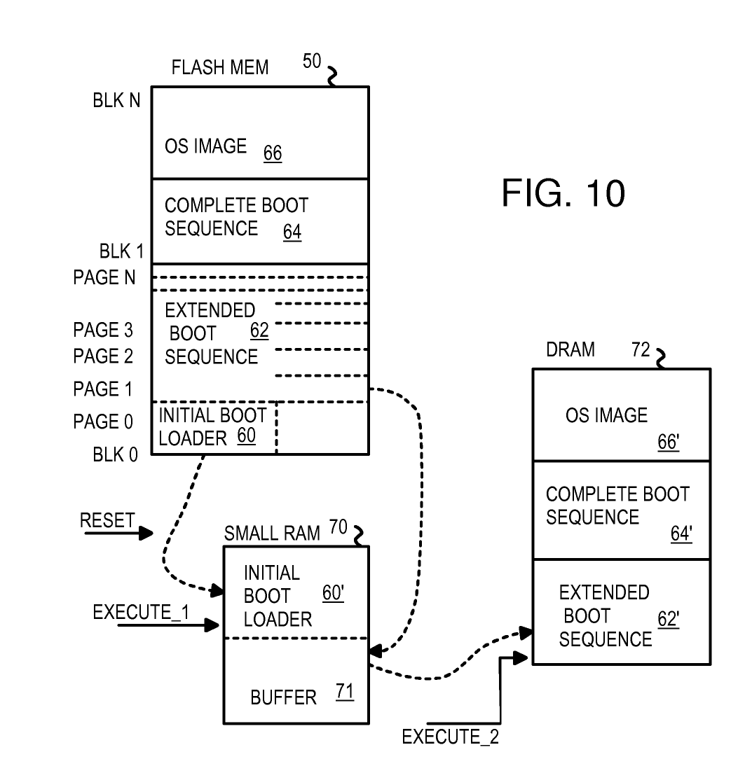

FIG. 9 shows boot code stored in a NAND flash memory. NAND flash memory 50 is block-accessible, allowing pages in a block to be written just once before the whole block is erased. Entire pages are read as a 512-byte page; individual bytes cannot be read or written.

NAND flash memory 50 stores initial boot loader 60 at the first page of the first block. Extended boot sequence 62 is stored after initial boot loader 60 in the other pages of the first block. Complete boot sequence 64 is stored in the next block. OS image 66 is stored next, after complete boot sequence 64.

User data 54 is the main user or application data stored by flash memory 50. Unused user storage 52 is available for new data.

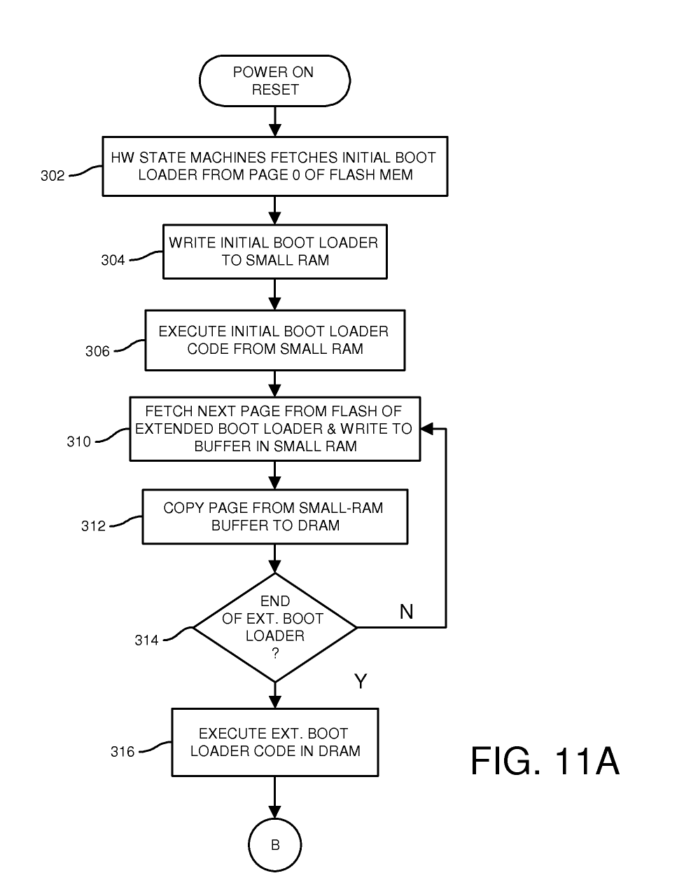

FIG. 10 highlights booting the SD flash microcontroller from multiple memories. DRAM 72 is volatile, losing all data when power is lost. DRAM 72 can be external to SD flash microcontroller 100. Small RAM 70 is a small RAM on SD flash microcontroller 100 that is used during booting. Small RAM 70 may be a SRAM that is used for other purposes after booting is complete, such as being used as a cache or as a FIFO buffer. Small RAM 70 could be part of a RAM array that includes cache 79 or FIFO 94 of FIG. 5. Small RAM 70 could be as small as 2 pages (1K bytes) in size.

Small RAM 70 is also volatile, losing data when power is lost. Flash memory 50 is non-volatile, retaining data such as boot code. However, code cannot be executed directly from flash memory 50, since flash memory 50 is block-addressable. A whole page must be read from flash memory 50, rather than individual cache lines or instructions.

After reset, a state machine or other hardware in SD flash microcontroller 100 reads the first page of the first block of flash memory 50. This first page contains initial boot loader 60, which is written by the hardware state machine into small RAM 70. Initial boot loader 60 may occupy the entire 512-byte first page, or just part of the first page, or multiple pages.

After loading initial boot loader 60 into small RAM 70, the CPU exits reset and begins fetching instructions from the first address in small RAM 70. Initial boot loader copy 60′ is located there, causing initial boot loader copy 60′ to be executed directly by the CPU. Initial boot loader copy 60′ contains CPU instructions that cause the CPU to read the remaining pages in the first block of flash memory 50. These pages contain extended boot sequence 62. The remaining area of small RAM 70 is used as temporary buffer 71 to store pages of extended boot sequence 62 as they are copied to DRAM 72 and stored as extended boot sequence copy 62′.

Once all pages of extended boot sequence 62 have been copied to DRAM 72, then the CPU writes to registers in bus logic and registers 42 to alter bus muxing. Rather than read instructions from small RAM 70, the CPU reads instructions from DRAM 72, such as through a DRAM interface. The CPU may be reset to cause it to again fetch instructions from address 0, which is now the first address in DRAM 72.

Instructions from extended boot sequence copy 62′ are now read and executed by the CPU. These instructions include routines to read complete boot sequence 64 from the next block of flash memory 50, and to write these instructions to DRAM 72 as complete boot sequence copy 64′. As the last instruction of extended boot sequence copy 62′ is executed, the next instruction fetched is from complete boot sequence copy 64′, either fetching sequentially or by a jump or branch.

Complete boot sequence copy 64′ is then executed by the CPU. Complete boot sequence 64 includes instructions to read OS image 66 from flash memory 50, and to write it to DRAM 72 as OS image copy 66′. As the last instruction of Complete boot sequence copy 64′ is executed, the next instruction fetched is from OS image copy 66′, either fetching sequentially or by a jump or branch. After the OS starts, user or application programs may be loaded and executed.

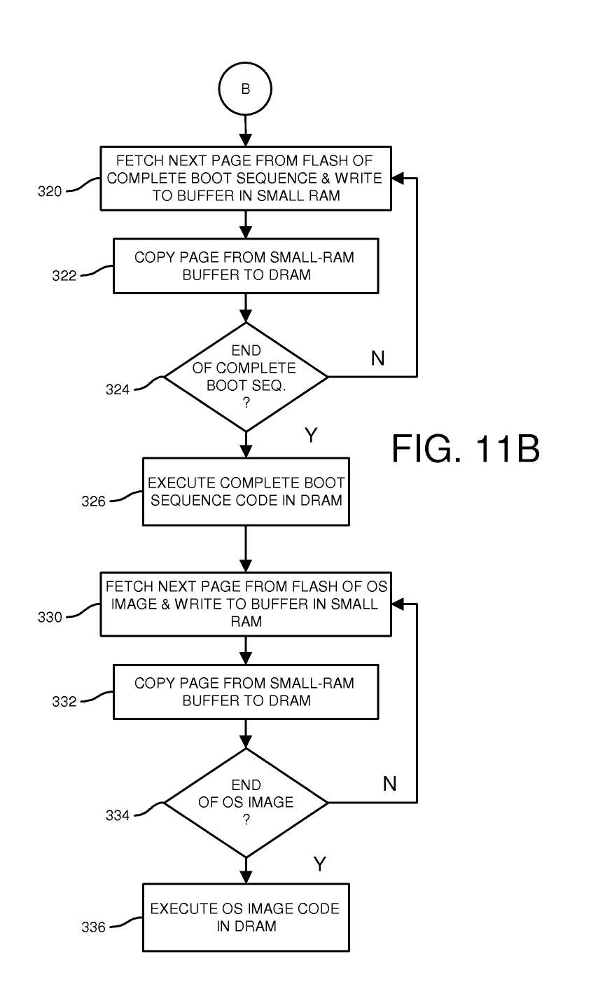

FIGS. 11A-B is a flowchart of booting a SD flash microcontroller from flash, SRAM, and DRAM. In FIG. 11A, when power is turned on the chips are reset, including SD flash microcontroller 100. A hardware state machine or other hardwired logic reads and fetches the first page of the first block of flash memory, step 302. The flash memory chip itself may supply this first page after reset.

This first page in flash contains initial boot loader 60. Initial boot loader 60 is written into small RAM 70, step 304. The CPU is then activated, such as by bringing the CPU out of reset, and begins fetching and executing instructions from address 0 in the small RAM. The initial boot loader was written to these first addresses in the small RAM in step 304, so the initial boot loader is executed from the small RAM, step 306.

As the initial boot loader is executed by the CPU from the small RAM, the next page in the flash memory is read and this next page is written to a buffer area of the small RAM, step 310. The small RAM can be 2 or more pages in size, such as 1K bytes. The next page from flash is then copied from the buffer area of the small RAM to the DRAM, starting at address 0 in the DRAM, step 312.

Steps 310, 312 are repeated when there are more pages of extended boot sequence 62 to fetch from the flash memory, step 314. When all pages of extended boot sequence 62 have been copied, step 314, then extended boot sequence 62 is executed from the first address in the DRAM, step 316. The CPU may write a register in bus logic and registers 42 such as a RAM_BASE bit to cause the CPU to fetch from DRAM rather than the small RAM. Then the CPU may be reset to begin fetching from DRAM.

In FIG. 11B, as extended boot sequence 62 is being executed from DRAM, pages of complete boot sequence 64 are read from flash memory, step 320, and written to the buffer area of the small RAM. The page of the complete boot sequence is then copied from the buffer area of the small RAM to the next free page in DRAM, step 322.

Pages in the buffer area of the small RAM may be over-written with new pages once the older pages have been copied to DRAM. A verification process may also be performed after each page is copied, or a checksum may be calculated and compared to a stored checksum.

When more pages of complete boot sequence 64 still remain to be fetched, step 324, then steps 320, 322 are repeated until all pages in complete boot sequence 64 have been copied to DRAM. Then the complete boot sequence can be executed from DRAM, such as by jumping from an instruction in the extended boot sequence to an instruction in the complete boot sequence, or by fetching sequentially across the boundary in DRAM between extended boot sequence 62 and complete boot sequence 64. Since both are in DRAM, a reset is not needed.

As complete boot sequence 64 is executed from DRAM, step 326, pages in flash memory continue to be read that contain OS image 66. These pages may be in several consecutive blocks of flash memory. Each page of OS image 66 is read from the flash memory and written to the buffer area of the small RAM, step 330, and then copied from the buffer area to the next available page in DRAM, step 332. Additional pages are fetched by repeating steps 330, 332, until all pages of OS image 66 have been copied to DRAM, step 334. Then execution transfers from complete boot sequence 64 to OS image 66, such as by a jump instruction being executed by complete boot sequence 64 that has a target in OS image 66, step 336. Application and user programs may then be loaded and executed by the OS.

The buffer area of the small RAM could be expanded to include the area in small RAM 70 that was occupied by initial boot loader 60 after initial boot loader 60 has finished execution. This can allow 2 or more pages to be transferred in each step rather than just one page. Also, the size of the buffer area may be large enough for several pages to be transferred together, possibly improving performance.

BOT Mode for Universal-Serial-Bus (USB)

According to another aspect of the invention, described more fully in the parent application, U.S. Ser. No. 11/466,759, an input/output interface circuit is activated so as to establish USB Bulk Only Transport (BOT) communications with the host computer via the interface link. There are four types of USB software communication data flow between a host computer and the USB interface circuit of the flash memory device (also referred to as a “USB device” below): control, interrupt, bulk, and isochronous. Control transfer is the data flow over the control pipe from the host computer to the USB device to provide configuration and control information to a USB device. Interrupt transfers are small-data, non-periodic, guaranteed-latency, device-initiated communication typically used to notify the host computer of service needed by the USB device. Movement of large blocks of data across the USB interface circuit that is not time critical relies on Bulk transfers. Isochronous transfers are used when working with isochronous data. Isochronous transfers provide periodic, continuous communication between the host computer and the USB device. There are two data transfer protocols generally supported by USB interface circuits: Control/Bulk/Interrupt (CBI) protocol and Bulk-Only Transfer (BOT) protocol. The mass storage class CBI transport specification is approved for use with full-speed floppy disk drives, but is not used in high-speed capable devices, or in devices other than floppy disk drives (according to USB specifications). In accordance with an embodiment of the present invention, a USB flash device transfers high-speed data between computers using only the Bulk-Only Transfer (BOT) protocol. BOT is a more efficient and faster transfer protocol than CBI protocol because BOT transport of command, data, status rely on Bulk endpoints in addition to default Control endpoints.

As with previous embodiments described above, the processing unit is selectively operable in a programming mode, where the processing unit causes the input/output interface circuit to receive the data file from the host computer, and to store the data file in the flash memory device through write commands issued from the host computer to the flash memory controller, a data retrieving mode, where the processing unit receives the data in the flash memory device through read command issued from the host computer to the flash memory controller and to access the data file stored in the flash memory device, and activates the input/output interface circuit to transmit the data file to the host computer, and a data resetting mode where the data file is erased from the flash memory device.

Advantages of the intelligent processing unit in accordance with the present invention include:

(1) providing high integration, which substantially reduces the overall space needed and reduces the complexity and the cost of manufacturing. (2) utilizing an intelligent algorithm to detect and access the different flash types, which broadens the sourcing and the supply of flash memory; (3) by storing the portion of software program along with data in flash memory which results in the cost of the controller being reduced; and (4) utilizing more advanced flash control logic which is implemented to raise the throughput for the flash memory access.

In accordance with another embodiment of the present invention, a system and method is provided for controlling flash memory in an electronic data flash card. The system and method provide a flash memory controller including a processor for receiving at least one request from a host system, and an index, which comprises look-up tables (LUTs) and a physical usage table (PUT). The index translates logical block addresses (LBAs) provided by the host system to physical block addresses (PBAs) in the flash memory. The index also contains information regarding the flash memory configuration. The processor selectively utilizes the index to determine the sectors of the flash memory that are available for programming, reprogramming, or reading. The flash memory controller further comprises a recycling first-in-first-out (FIFO) that recycles blocks of obsolete sectors so that they are available for reprogramming. The recycling operation involves copy and erase operations, and is performed in the background and thus hidden from the host system. Accordingly, the management of the flash memory and related intelligence resides in the flash memory controller instead of in the host system. As a result, the host system interacts with the flash memory controller without the host system having information regarding the physical configuration of the flash memory. Consequently, speeds at which data is written to and read from the flash memory is significantly increased while the flash memory remains compatible with the USB standard and ASIC architecture.

The following terms are defined as indicated in accordance with the present invention. Block: A basic memory erase unit. Each block contains numerous sectors, e.g., 16, 32, 64, etc. If any sector encounters write error, the whole block is declared a bad block and all valid sectors within the block are relocated to another block. Sector: A sub-unit of a block. Each sector typically has two fields—a data field and a spare field. Obsolete sector: A sector that is programmed with data but the data has been subsequently updated. When the data is updated, the obsolete data remains in the obsolete sector and the updated data is written to new sectors, which become valid sectors. Non-valid blocks: Blocks that contain obsolete sectors. Valid sector: A sector that has been programmed with data and the data is current, i.e., not obsolete. Wear leveling: A method for evenly distributing the number times each block of flash memory is erased in order to prolong the life of the flash memory. Flash memory can be block erased only a limited number of times. For example, one million is a typical maximum number of erases for NAND flash memory. Spare blocks: Reserved space in flash memory. Spare blocks enable flash memory systems to prepare for bad blocks. Cluster: Multiple data sectors used as file access pointers by an operating system to improve memory performance. In small mass-storage memory operation, a cluster normally is a combination of two data sectors, which is a minimum file size unit. 1 k byte is a typical cluster size for small blocks of memory (i.e., 512 bytes per sector), and 4 k bytes is a cluster size for larger blocks of memory (i.e., 2,112 bytes per sector). FAT: File allocation table having file address-linked pointers. A cluster is the unit for a FAT. For example, FAT16 means that a cluster address can be 16 bits. Directory and subdirectory: File pointers as defined by an operating system. Master boot record (MBR): A fixed location to store a root directory pointer and associated boot file if bootable. This fixed location can be the last sector of the first block, or the last sector of the second block if first block is bad. Packet: A variable length format for a USB basic transaction unit. A normal transaction in the USB specification typically consists of three packets—a token packet, a data packet, and a handshake packet. A token packet has IN, OUT, and SETUP formats. A data packet size can be varying in size, e.g., 64 bytes in USB revision 1.1, and 512 bytes in USB revision 2.0. A handshake packet has ACK or NAK formats to inform host of the completion of a transaction. Frame: A bulk transaction that is used that has a high priority for occupying a frame if USB traffic is low. A bulk transaction can also wait for a later frame if USB traffic is high. Endpoint: Three endpoints include control, bulk-in, and bulk-out. The control endpoint is dedicated to system initial enumeration. The bulk-in endpoint is dedicated to host system read data pipe. The bulk-out endpoint is dedicated to a host system write data pipe. Command block wrapper (CBW): A packet contains a command block and associated information, such as Data Transfer Length (512 bytes for example from byte 8-11). A CBW always starts at the packet boundary, and ends as short packet with exactly 31 bytes transferred. All CBW transfers shall be ordered with LSB (byte 0) first. Command Status Wrapper (CSW): A CSW starts at packet boundary. Reduced block command (RBC) SCSI protocol: a 10 byte command descriptor.

According to the system and method disclosed herein, the present invention provides numerous benefits. For example, it shifts the management of the flash memory and related intelligence from the host system to the flash memory controller so that the host system interacts with the flash memory controller without the host system having information regarding the configuration of the flash memory. For example, the flash memory controller provides LBA-to-PBA translation, obsolete sector recycling, and wear leveling. Furthermore, the recycling operations are performed in the background. Furthermore, flash specific packet definitions and flags in the flash memory are eliminated. Furthermore, the flash memory controller provides multiple-block data access, dual channel processing, and multiple bank interleaving. Consequently, speeds at which data is written to and read from the flash memory is significantly increased while the flash memory remains compatible with the USB standard and ASIC architecture.

A system and method in accordance with the present invention for controlling flash memory are disclosed. The system and method comprise a processor for receiving at least one request from a host system, and an index, which comprises look-up tables (LUTs) and a physical usage table (PUT). The index translates logical block addresses (LBAs) provided by the host system to physical block addresses (PBAs) in the flash memory. The index also contains intelligence regarding the flash memory configuration. The processor can utilize the index to determine the sectors of the flash memory that are available for programming, reprogramming, or reading. The flash memory controller further comprises a recycling first-in-first-out (FIFO) that recycles blocks having obsolete sectors so that they are available for reprogramming. The recycling operation involves copy and erase operations, and is performed in the background and thus hidden from the host system. Accordingly, the management of the flash memory and related intelligence resides in the flash memory controller instead of in the host system. As a result, the host system interacts with the flash memory controller without the host system having information regarding the configuration of the flash memory. Consequently, speeds at which data is written to and read from the flash memory is significantly increased while the flash memory remains compatible with the USB standard and ASIC architecture.

### Alternate Embodiments

Several other embodiments are contemplated by the inventors. For example different numbers and arrangements of flash, RAM, and SD cards or SD hosts can connect to the controller. Rather than use SD buses, other buses may be used such as Memory Stick, PCI Express bus, Compact Flash (CF), IDE bus, Serial ATA (SATA) bus, etc. Additional pins can be added or substituted for the SD data pins. A multi-bus-protocol chip could have an additional personality pin to select which bus interface to use, or could have programmable registers. Rather than have a SD microcontroller, a Memory Stick microcontroller could be substituted, for use with a memory-stick interface, etc.

Rather than write extended boot sequence 62 to address 0 in the DRAM, it can be written to another address in DRAM when the CPU can be configured to execute from an address other than address 0. Likewise, the first address fetched and executed in small RAM 70 may not be address 0.

While a page size of 512 bytes has been described, other pages sizes could be substituted, such as 1K, 2K, 4K, etc. Flash blocks may have 4 pages, 8 pages, 64 pages, or some other number, depending on the physical flash chips and arrangement used.

While the invention has been described using an SD controller, a MMC controller may be substituted. A combined controller that can function for both MMC and SD may also be substituted. SD may be considered an extension of MMC, or a particular type of MMC, rather than a separate type of bus.

While the invention has been described as not requiring ROM for booting, some ROM may still be present on the chip. For example, a revision number may be included in a small ROM. Hard-wired gates that are tied to power or ground may also function as a read-only memory. While such ROM may be present, ROM is not required for storing boot code or booting instructions. A few bytes or more of ROM may be thus present for other purposes.

Mode logic could sense the state of a pin only at power-on rather than sense the state of a dedicated pin. A certain combination or sequence of states of pins could be used to initiate a mode change, or an internal register such as a configuration register could set the mode.

The microcontroller and SD components such as the bus interface, DMA, flash-memory controller, transaction manager, and other controllers and functions can be implemented in a variety of ways. Functions can be programmed and executed by the CPU or other processor, or can be implemented in dedicated hardware, firmware, or in some combination. Many partitioning of the functions can be substituted.

Data and commands may be routed in a variety of ways, such as through data-port registers, FIFO or other buffers, the CPU's registers and buffers, DMA registers and buffers, and flash registers and buffers. Some buffers may be bypassed or eliminated while others are used or present. Virtual or logical buffers rather than physical ones may also be used. Data may be formatted in a wide variety of ways.

The host can transfer standard SD commands and data transactions to the SD transceiver during a transaction. Other transaction types or variations of these types can be defined for special purposes. These transactions may include a flash-controller-request, a flash-controller-reply, a boot-loader-request, a boot-loader-reply, a control-program-request, a control-program-reply, a flash-memory-request, and a flash-memory-reply. The flash-memory request/reply may further include the following request/reply pairs: flash ID, read, write, erase, copy-back, reset, page-write, cache-write and read-status.

The host may be a personal computer (PC), a portable computing device, a digital camera, a phone, a personal digital assistant (PDA), or other electronic device. The small RAM could be internal to SD flash microcontroller 100 or could be external. ROM 44 in FIGS. 6-8 could be replaced by small RAM 70, while RAM 34 could be replaced by the DRAM. Small RAM 70 could be part of a RAM array that includes cache 79 or FIFO 94 of FIG. 5. The partition of RAM among various functions could change over time.

Wider or narrower data buses and flash-memory blocks could be substituted, such as 4, 5, 8, 16, 32, 64, 128, 256-bit, or some other width data channels. Alternate bus architectures with nested or segmented buses could be used internal or external to the microcontroller. Two or more internal and flash buses can be used in the SD flash microcontroller to increase throughput. More complex switch fabrics can be substituted for the internal buses.

The flash mass storage chips or blocks can be constructed from any flash technology including multi-level-logic (MLC) memory cells. Data striping could be used with the flash mass storage blocks in a variety of ways, as can parity and error-correction code (ECC). Data re-ordering can be adjusted depending on the data arrangement used to prevent re-ordering for overlapping memory locations. An SD/MMC switch could be integrated with other components or could be a stand-alone chip. The SD/MMC switch could also be integrated with the SD single-chip flash device. While a single-chip device has been described, separate packaged chips or die may be stacked together while sharing I/O pins, or modules may be used.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A flash microcontroller comprising:
an input/output interface circuit for establishing communication with a host computer, wherein the input/output interface circuit includes a Universal Serial Bus (USB) interface circuit including means for transmitting data using a Bulk Only Transport (BOT) protocol;
a flash bus for connecting to a flash-memory chip, the flash bus carrying address, data, and commands to the flash-memory chip;
wherein the flash-memory chip stores first instructions and stores second instructions in a non-volatile memory;
an internal bus coupled to the input/output interface circuit;
a first random-access memory (RAM) for storing first instructions for execution, the first RAM on the internal bus;
a RAM interface to a second RAM for storing second instructions for execution;
wherein the first RAM and the second RAM are volatile memories that lose data when power is removed;
a central processing unit (CPU), on the internal bus, the CPU accessing and executing the first instructions in the first RAM during a first mode and accessing and executing the second instructions in the second RAM during a second mode;
a flash-memory controller, on the internal bus, for generating flash-control signals and for buffering commands, addresses, and data to the flash bus;
a hardwired initializer, activated by a reset signal, for activating the flash-memory controller to read the first instructions from the flash-memory chip, the hardwired initializer writing the first instructions to the first RAM;
a first initialization routine, executed by the CPU while in the first mode after the reset signal is de-asserted, the first initialization routine comprising the first instructions stored in the first RAM;
wherein the first initialization routine activates the flash-memory controller to read the second instructions from the flash-memory chip, the first initialization routine writing the second instructions to the second RAM; and
a second initialization routine, executed by the CPU while in the second mode, the second initialization routing comprising second instructions stored in the second RAM,
whereby the flash microcontroller is booted from both the first RAM and from the second RAM by the first and second initialization routine.

2. The flash microcontroller of claim 1 further comprising:
a mode register for indicating the first mode wherein the CPU accesses and executes first instructions in the first RAM and does not execute second instructions from the second RAM, and for indicating the second mode wherein the CPU accesses and executes the second instructions in the second RAM and does not execute the first instructions from the first RAM,
whereby the CPU operates in the first mode, fetching the first instructions from the first RAM, or operates in the second mode, fetching second instructions from the second RAM.

3. The flash microcontroller of claim 2 further comprising:
a multiplexer, coupled to the first RAM and coupled to second RAM through the RAM interface, and responsive to the mode register, for sending the first instructions from the first RAM to the CPU and for disabling transfer of the second instructions to the CPU when the mode register indicates the first mode, and sending the second instructions from the second RAM to the CPU and for disabling transfer of the first instructions to the CPU when the mode register indicates the second mode.

4. The flash microcontroller of claim 2 further comprising:
a clocked-data interface to a host bus that connects to a host;
a bus transceiver for detecting and processing commands sent over the host bus;
a buffer for storing data sent over the host bus.

5. The flash microcontroller of claim 4 further comprising:
a direct-memory access (DMA) engine, on the internal bus, for transferring data over the internal bus.

6. The flash microcontroller of claim 4 further comprising:
wherein the host bus is a Secure Digital (SD) protocol bus operating according to a host-bus protocol.

7. The flash microcontroller of claim 2 wherein the flash bus further comprises a host bus that connects to a host and to the flash-memory chip, further comprising:
a clocked-data interface to the host bus that connects to a host;
a bus transceiver for detecting and processing commands sent over the host bus;
a buffer for storing data sent over the host bus.

8. The flash microcontroller of claim 2 wherein the flash-memory chip reads and writes flash pages of at least 512 bytes, the flash-memory chip reading or writing entire flash pages, the flash-memory chip not being accessible for amounts of data less than a whole flash page,
whereby the flash-memory chip is block-addressable and not randomly-accessible.

9. A method for booting a flash microcontroller comprising:
applying power to the flash microcontroller that is connected to a large random-access memory (RAM);
holding a central processing unit CPU in a reset state after power is applied;
while the CPU is in the reset state, activating a state machine on the flash microcontroller to read an initial boot loader from a first page in a first block of a flash memory coupled to the flash microcontroller by a flash bus;
using the state machine to write the initial boot loader to a small RAM in the flash microcontroller;
releasing the CPU from the reset state, causing the CPU to fetch instructions of the initial boot loader stored in the small RAM;
executing on the CPU the initial boot loader by fetching instructions in the initial boot loader from the small RAM;
reading a next page from the flash memory after the first page and writing the next page to a buffer area of the small RAM as the initial boot loader is executed;
reading the next page from the buffer area of the small RAM and writing the next page to the large RAM as the initial boot loader is executed;
continuing to read next pages from the flash memory and copy the next pages through the buffer area to the large RAM as the initial boot loader is executed until all pages of an extended boot sequence have been copied to the large RAM;
transferring execution from the small RAM to the large RAM;
executing on the CPU the extended boot sequence by fetching instructions in the extended boot sequence from the large RAM;
reading a next page from the flash memory after the extended boot sequence and writing the next page to the buffer area of the small RAM as the extended boot sequence is executed;
reading the next page from the buffer area of the small RAM and writing the next page to the large RAM as the extended boot sequence is executed;
continuing to read next pages from the flash memory and copy the next pages through the buffer area to the large RAM as the extended boot sequence is executed until all pages of a complete boot sequence have been copied to the large RAM;
transferring execution from the extended boot sequence to the complete boot sequence by executing a last instruction in the extended boot sequence that causes the CPU to fetch a first instruction in the complete boot sequence from the large RAM; and
fetching and executing the complete boot sequence;
establishing communication with a host computer using an input/output interface circuit, wherein the input/output interface circuit includes a Universal Serial Bus (USB) interface circuit;
transmitting data using a Bulk Only Transport (BOT) protocol with the input/output interface circuit,
whereby the flash microcontroller is booted by fetching and executing instructions from both the small RAM and from the large RAM.

10. The method of claim 9 wherein fetching and executing the complete boot sequence further comprises:
executing on the CPU the complete boot sequence by fetching instructions in the complete boot sequence from the large RAM;
reading a next page from the flash memory after the complete boot sequence and writing the next page to the buffer area of the small RAM as the complete boot sequence is executed;
reading the next page from the buffer area of the small RAM and writing the next page to the large RAM as the complete boot sequence is executed;
continuing to read next pages from the flash memory and copy the next pages through the buffer area to the large RAM as the complete boot sequence is executed until all pages of a operating system image have been copied to the large RAM; and
transferring execution from the complete boot sequence to the operating system image by executing a last instruction in the complete boot sequence that causes the CPU to fetch a first instruction in the operating system image from the large RAM,
whereby the complete boot sequence loads the operating system image.

11. The method of claim 10 wherein transferring execution from the small RAM to the large RAM comprises:
writing a control register to change from a small-RAM mode to a large-RAM mode, wherein the CPU fetches instructions from the small RAM during the small-RAM mode, and wherein the CPU fetches instructions from the large RAM during the large-RAM mode,
whereby the control register controls fetching from the small RAM and from the large RAM.

12. The method of claim 11 wherein transferring execution to the large RAM further comprises:
resetting the CPU after the initial boot loader has finished copying the extended boot sequence to the large RAM,
whereby the CPU transfers execution to the large RAM by being reset.

13. The method of claim 12 wherein transferring execution to the large RAM further comprises:
reading an initial extended instruction from an initial extended address in the large RAM after the CPU is reset, wherein the initial extended address contains an instruction in the extended boot sequence.

14. The method of claim 13 wherein transferring execution from the extended boot sequence to the complete boot sequence by executing the last instruction in the extended boot sequence that causes the CPU to fetch the first instruction in the complete boot sequence from the large RAM further comprises:
executing a sequential instruction as the last instruction, wherein the first instruction sequentially follows the last instruction in the large RAM.

15. The method of claim 13 wherein transferring execution from the extended boot sequence to the complete boot sequence by executing the last instruction in the extended boot sequence that causes the CPU to fetch the first instruction in the complete boot sequence from the large RAM further comprises:
executing a jump instruction as the last instruction, wherein the first instruction is separated from the last instruction by intervening instructions.

16. A multi-interface microcontroller comprising:
input/output interface circuit means for establishing communication with a host computer, wherein the input/output interface circuit means includes a Universal Serial Bus (USB) interface circuit including means for transmitting data using a Bulk Only Transport (BOT) protocol;
flash bus means for connecting to a flash memory, the flash bus means carrying address, data, and commands to the flash memory;
wherein the flash memory stores an initial boot loader, an extended boot sequence, and a complete boot sequence in a non-volatile memory;
first volatile memory means for storing first instructions for execution;
second memory interface means for interfacing to a second volatile memory means for storing second instructions for execution;
processor means, coupled to the input/output interface circuit means, for fetching and executing the first instructions in the first volatile memory means during a first mode and fetching and executing the second instructions from the second volatile memory means during a second mode;
flash-memory controller means for generating flash-control signals and for buffering commands, addresses, and data to the flash bus means;
hardwired initializer means, activated by a reset signal, for activating the flash-memory controller means to read the initial boot loader from the flash memory, and for writing the initial boot loader as the first instructions to the first volatile memory means;
initial boot loader execution means for activating the processor means to fetch and execute the first instructions from the first volatile memory means, the initial boot loader execution means for activating the flash-memory controller means to read the extended boot sequence from the flash memory, and for writing the extended boot sequence as the second instructions to the second volatile memory means; and
extended boot sequence execution means for activating the processor means to fetch and execute the second instructions from the second volatile memory means, the extended boot sequence execution means for activating the flash-memory controller means to read the complete boot sequence from the flash memory, and for writing the complete boot sequence as additional second instructions to the second volatile memory means.

17. The multi-interface microcontroller of claim 16 further comprising:
transfer means for transferring execution by the processor means from the first volatile memory means to the second volatile memory means.

18. The multi-interface microcontroller of claim 17 wherein the transfer means further comprises:
control register means for indicating a first mode and a second mode;
wherein the processor means fetches instructions from the first volatile memory means during the first mode;
wherein the processor means fetches instructions from the second volatile memory means during the second mode; and
toggle means, activated by the initial boot loader execution means, for changing the control register means from the first mode to the second mode before the extended boot sequence execution means is activated.

19. The multi-interface microcontroller of claim 18 further comprising:
reset means for resetting the processor means after the toggle means is activated.

20. The multi-interface microcontroller of claim 16 further comprising:
multiplexer means, coupled to the first volatile memory means and to the second volatile memory means, and responsive to the control register means, for sending the first instructions from the first volatile memory means to the processor means and for disabling transfer of the second instructions to the processor means when the control register means indicates the first mode, and sending the second instructions from the second volatile memory means to the processor means and for disabling transfer of the first instructions to the processor means when the control register means indicates the second mode.
